(19) United States
(12) Patent Application Publication
(10) Pub. No.: US 2013/0299018 A1
(43) Pub. Date: Nov. 14, 2013

(54) HIGH DENSITY POLYETHYLENE ACID AND WATER TANK MANIFOLD

(71) Applicant: FIRST AUGUSTA, LLC DBA KALACO EQUIPMENT, Odessa, TX (US)

(72) Inventor: RAY ELLIOTT, ODESSA, TX (US)

(73) Assignee: First Augusta, LLC dba Kalaco Equipment, Odessa, TX (US)

(21) Appl. No.: 13/649,624

(22) Filed: Oct. 11, 2012

Related U.S. Application Data
(60) Provisional application No. 61/645,247, filed on May 10, 2012.

(51) Int. Cl. F16L 41/02

(52) U.S. Cl. 137/561 A

(57) ABSTRACT

A manifold for use with a tank in acid service includes a cylindrical main body having a central longitudinal axis, a tank connection and a plurality of parallel outlet connections in fluid communication with the cylindrical main body. The outlet connections are spaced apart at equal intervals along the main body and extend perpendicular to the central longitudinal axis of the main body. The cylindrical main body, the tank connection and outlet connections are each fabricated from a high density polyethylene having a density of from 0.956 to 0.964 gm/cm³. In one aspect, the manifold is fabricated from a high density polyethylene having a melt index of <0.15 gm/10 min., a flexural modulus of 110,000 to 160,000 psi and a tensile strength of >3600 psi. The high density polyethylene has a slow crack growth rate of >1000 hours, environmental stress cracking rate of >5000 hours.

### CROSS-REFERENCE TO RELATED APPLICATIONS

This applications claims benefit of U.S. Provisional Application No. 61/645,247, filed on May 10, 2012, and entitled MANIFOLD FOR USE IN OIL FRACKING BUSINESS.

### TECHNICAL FIELD

The disclosure relates to manifolds for acid service and, in particular, manifolds fabricated from high density polyethylene suitable for use with acid tanks in fracking operations.

### BACKGROUND

Induced hydraulic fracturing (“hydrofracking”) is a technique for propagating fractures in a rock formation to release liquid hydrocarbons and natural gas from the formations for extraction. Typically, a highly pressurized fluid is injected into a well bore drilled in a reservoir rock formation. The fluid pressure creates or widens channels in the rock which releases trapped hydrocarbons and gas, increasing the extraction rates and recovery of hydrocarbons from the reservoir. Fluids used for hydraulic fracturing are normally water-based solutions, foams or gels that may contain friction-reducing additives, emulsifiers, biocides and poppant (a material that will hold or keep an induced fracture open, for example, sand or ceramics).

One additive commonly used in hydraulic fracturing is hydrochloric acid. The acid may be injected into the formation to clean up and clear the well bore prior to extraction or additional hydraulic fracturing. Acid may also be used in carbonate and sandstone formations to dissolve some of the rock material and to clean out pores, create pores and fractures and/or to enlarge and clear existing pores and natural fractures. Significant amounts of acid may be used in these processes. The acid must be stored on site in sufficient quantities and be stored in such a manner that relatively large volumes can be rapidly deployed. Since the use of acid in hydraulic fracturing occurs over a relatively short time period, portable tanks are used to store the acid at the drill site and the required piping is often fabricated on site.

Much of the piping involved in well completion operations such as hydraulic fracturing is fabricated on site to accommodate site specific needs. However, on-site fabrication of piping for hydrochloric acid service can be problematic due to the properties of the acid. The concentration of the hydrochloric acid used in hydraulic fracturing is typically in the range of 35%. The acid is extremely corrosive, typically requiring special coatings and lining for storage tanks and piping. Off-site fabrication and transport of steel pipe with acid resistant coatings is expensive, and the coatings can be damaged during transport of the piping. On-site fabrication, e.g., welding of steel piping for hydrochloric acid service can be problematic, since bare steel pipe will corrode rapidly, especially at the weld locations, and welding coated pipe may damage or destroy the coating in the areas of the weld. This is particularly the case for manifolds used for hydrochloric acid storage. Further, transporting heavy, bulky steel pipe manifolds for hydrochloric acid tanks is expensive and often requires the use of heavy equipment to load, unload and transport the manifolds.

### SUMMARY

A manifold for use with a tank in acid service includes a cylindrical main body having a central longitudinal axis and a plurality of parallel outlet connections in fluid communication with the cylindrical main body. The outlet connections are spaced apart at equal intervals along the main body and extend perpendicular to the central longitudinal axis of the main body. A tank connection in fluid communication with the main body extends perpendicular to the central longitudinal axis of the main body from the cylindrical main body of the manifold. The tank connection is parallel to the outlet connections and positioned between and equidistant from an inner most two of the outlet connections. The tank connection is circumferentially spaced apart from the outlet connections by 180° on the main body of the manifold. The cylindrical main body, the tank connection and outlet connections are each fabricated from a high density polyethylene having a density of from 0.956 to 0.964 gm/cm³. In one aspect, the manifold is fabricated from a high density polyethylene having a melt index of <0.15 gm/10 min., a flexural modulus of 110,000 to 160,000 psi and a tensile strength of >3600 psi. The high density polyethylene has a slow crack growth rate of >1000 hours, environmental stress cracking rate of >5000 hours in 100% Igepal® and a hydrostatic design basis of 1600 psi.

In one variation, the tank connection and main body of the manifold have a nominal diameter of ten inches and are formed from a high density polyethylene pipe having an SDR of 11 with the outlet connections being formed from a high density polyethylene pipe having a nominal diameter of four inches and an SDR of 7. The ratio of the diameter of the main body of the manifold to the diameter of the tank connection may be 1:1 with the ratio of the diameter of the main body to the diameter of outlet connections being 10:4. The manifold may also include a high density polyethylene reducer at one or both ends of the manifold with a stainless steel extension pipe section extending from the reducer.

### BRIEF DESCRIPTION OF THE DRAWINGS

For a more complete understanding, reference is now made to the following description taken in conjunction with the accompanying Drawings in which:

FIG. 1 is a partial perspective view of an acid tank equipped with a high density polyethylene manifold according to the disclosure;

FIG. 2 is a partial cross-section of the manifold of FIG. 1;

FIG. 3 is a partial cross-section of the tank and manifold of FIG. 1; and

FIG. 4 is a partial cross-section of a second manifold according to the disclosure.

### DETAILED DESCRIPTION

Referring now to the drawings, wherein like reference numbers are used herein to designate like elements throughout, the various views and embodiments of a high density polyethylene acid and water tank manifold are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

As described herein, pipe manifolds for hydrochloric acid storage tanks used in hydraulic fracturing are fabricated from high density polyethylene. The high density polyethylene piping described herein is resistant to attack from hydrochloric acid pipe and can be readily fabricated. Tank manifolds fabricated from high density polyethylene as described herein are more economical to fabricate and to transport than comparable steel pipe manifolds since the high density polyethylene pipe is significantly lighter than comparable steel pipe.

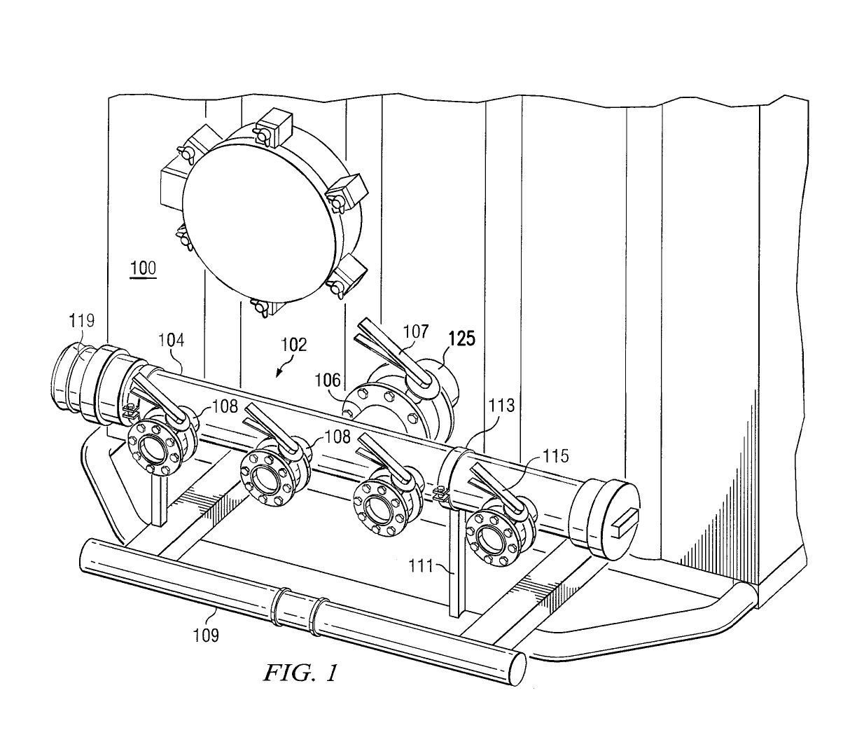

FIG. 1 is a perspective view of an acid tank 100 provided with a first manifold 102 as described herein. In different variations, acid tank 100 may have a rectangular or square cross-section or a circular cross-section. Tank 100 will typically have a capacity of about 500 barrels and may be lined with an acid resistant material. A plurality of tanks 100 may be piped together on site to provide the desired total acid storage. As illustrated, manifold 102 includes a cylindrical main body 104, a tank connection 106 connected to tank outlet 125 and four outlet connections 108. As illustrated, tank 100 and manifold 102 are skid mounted on frame 109 such that the tank may be transported with the manifold installed on the tank. Main body 104 of manifold 102 is supported adjacent each end of the manifold with supports 111 that extend upwardly from frame 109 to saddles 113 that encircle the main body of the manifold. A tank shut off valve 107 is provided between tank 100 and manifold 102 and each of outlet connections 108 is similarly provided with a shut off valve 115.

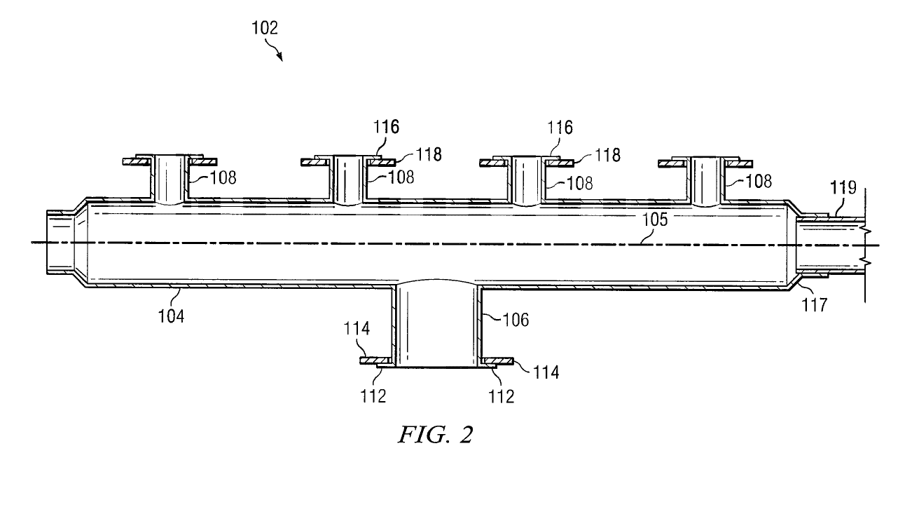

FIG. 2 is a sectional view of manifold 102 of FIG. 1. As illustrated, cylindrical main body 104 of manifold 102 has a longitudinal central axis 105, with four parallel, cylindrical outlet connections 108, each extending from cylindrical main body 104 of the manifold. Tank connection 106 and outlet connections 108 each extend from cylindrical main body 104 at an angle of ninety degrees relative to longitudinal central axis 105 of the cylindrical main body. The cylindrical tank connection 106 and cylindrical outlet connections 108 are parallel and circumferentially spaced apart 180° on main body 104 of manifold 102, e.g., tank connection 106 and outlet connections 108 extend from opposite sides of the cylindrical main body 104 of manifold 102. As illustrated, tank connection 106 is positioned between and equidistant from the inner most two of outlet connections 108 along the length of main body 104 of manifold 102. In different embodiments, some or all of outlet connections 108 may extend from main body 104 of manifold 102 at angles other than ninety degrees relative to the central longitudinal axis 105 of the main body, for example at thirty, or forty-fives degrees. Some or all of outlet connections 108 may also be circumferentially spaced on main body 104 at angles other than 180° from tank connection 106.

In the embodiment illustrated in FIG. 2, main body 104 is approximately 75 inches long, with tank connection 106 being centered midway along the length of the main body. Outlet connections 108 are spaced at 12 inch intervals (center-to-center) along the length of main body. Main body 104 and tank connection 106 have nominal diameters of ten inches, the same as tank outlet 125, while outlet connections 108 have nominal diameters of four inches. Thus, the ratio of the diameter of main body 104 to the diameter of tank connection 106 is 1:1 and the ratio of the diameter of main body 104 to the diameter of outlet connections 108 is 10:4. Main body 104 and tank connection 106 of manifold 102 are fabricated from SDR (Standard Dimension Ratio) 11 high density polyethylene pipe and outlet connections 108 are each fabricated from the same SDR 7 high density polyethylene pipe.

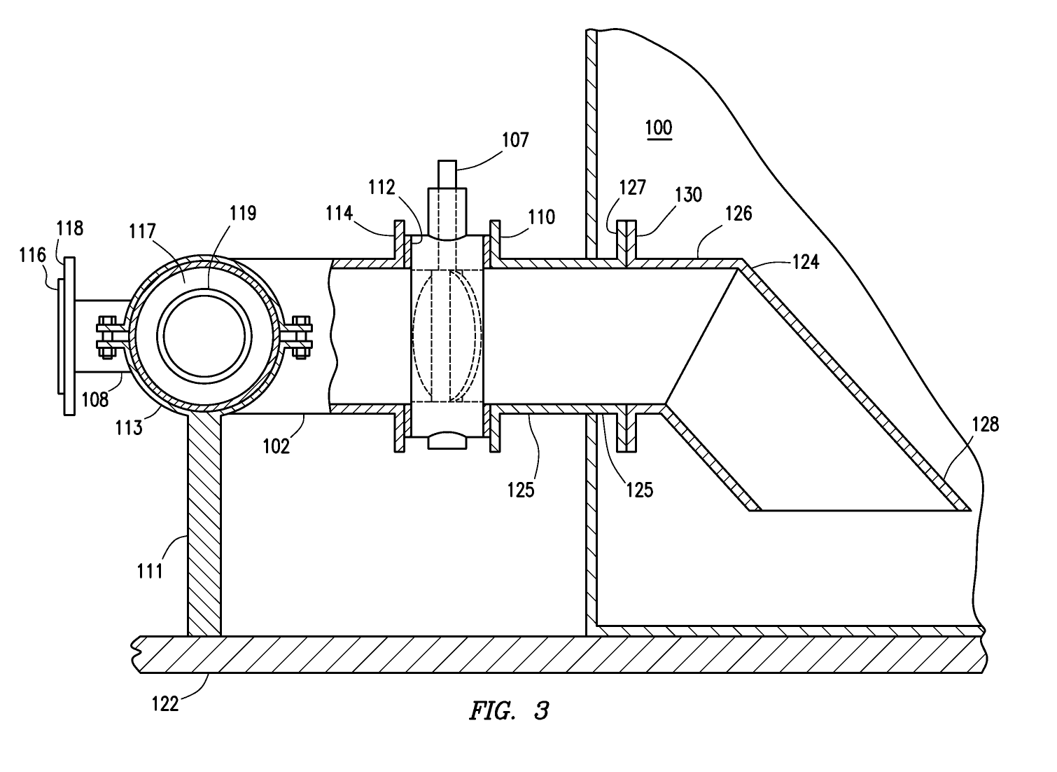

Referring still to FIG. 2, tank connection 106 includes a beveled flange adapter 112 having a ten inch diameter with a ductile iron back up ring 114 for connection to tank valve 107 (FIG. 1) or tank flange 110 (FIG. 3). Similarly, outlet connections 108 are provided with four inch beveled flange connectors 116 with ductile iron back up rings 118 for connection to valves 115. In one variation, the outermost surface of beveled flange adapter 112 is positioned twelve inches from the centerline of main body 104 of manifold 102. In the illustrated embodiment, manifold 102 includes a reducer 117 and an extension pipe 119 having a nominal diameter of eight inches at one or both ends of main body 104 for connecting the manifold to a manifold of an adjacent tank with a threaded flange adapter or similar connection. Alternatively, one or both ends of main body 104 of manifold 102 may be capped with a blind flange, a pipe cap or other fitting.

The outlet connections 108 of the manifold illustrated in FIGS. 1 and 2 are equally spaced apart along the length of main body 104 at 12 inch intervals, measured center-to-center, with the center of the outermost outlet connections being spaced 12 inches from the end of the main body. As illustrated, tank connection 106 is centered midway along the length of main body 104 between the two innermost outlet connections 108. In one embodiment, main body 104 and tank connection 106 are fabricated from SDR 11 high density polyethylene pipe, described below, with outlet connections 108 fabricated from SDR 7 high density polyethylene pipe.

The high density polyethylene of the pipe utilized to fabricate manifold 102 has excellent resistance to chemical attack by acids and mechanical properties that make the pipe suitable for use in the oil field environment. The high density polyethylene of the pipe used to fabricate manifold 102 has a density of 0.947 to 0.955 gm/cm³ (ASTM D 1505)(without carbon black), a melt index of <0.15 gm/10 min (ASTM D 1238), a flexural modulus of 110,000 to 160,000 psi (ASTM D 790) and a tensile strength of >3600 psi (ASTM D 638). With the addition of 2 to 2.5% carbon black (ASTM D 1630), the high density polyethylene has a density of from 0.956 to 0.964 gm/cm³. The slow crack growth of the high density polyethylene (PENT-ASTM F 1473) is >1000 hours and environmental stress cracking (ESCR-ASTM D 1693) is >5000 hours in 100% Igepal. The hydrostatic design basis (HDB-ASTM D 2837 @ 73° F.) of the high density polyethylene is 1600 psi. This is in contrast to other high density polyethylenes used for pipe fabrication which typically have a density in the range of 0.941 to 0.0943/cm³ (ASTM D 1505) (without carbon black) and a slow crack growth of the high density polyethylene (PENT -ASTM F 1473) of >100 hours.

FIG. 3 is a partial cross-sectional side view of the manifold 102 of FIG. 1 installed on tank 100. As illustrated, manifold 102 may be mounted on skid 122 adjacent tank 100 with supports 111 and saddles 113. This allows for transportation of tank 100 with manifold 102 connected to the tank. Supports 111 and saddles 113 also provide structural support for manifold 102 when acid is pumped into or out of tank 100.

In one embodiment, manifold 102 is connected via tank outlet 125 to a high density polyethylene suction line 124 that extends into tank 100 below the level of the tank outlet and manifold 102. As illustrated, tank outlet 125 extends into tank 100 and is provided with an internal flange 127. Suction line 124 is connected to internal flange 127 by means of a beveled or flat flange 130 that may be bolted to internal flange 129 with corrosion resistant stainless bolts (not shown). Suction line 124 includes a horizontal section 126 with beveled flange connector 130, and a downwardly angled section 128. Angled section 128 may extend at an angle of 45° relative to horizontal section 126 and to a desired depth or level in tank 100. Suction line 124 may be fabricated from the same SDR 11 high density polyethylene pipe (described above) used to fabricate manifold 102. As will be appreciated, suction line 124 allows the fluid level in the tank to be drawn down below the level of tank outlet 125 and manifold 102.

As previously noted, manifold 102 may include a reducer 117 and an extension pipe 119 having a nominal diameter of eight inches at one or both ends of main body 104 for connecting the manifold to a manifold of an adjacent tank with a threaded flange adapter or similar connection. Reducer 117 may be formed from the same high density polyethylene described above while pipe extension 119 may be fabricated from a stainless steel such as 304 stainless pipe. In other variations, extension pipe 119 may be fabricated from a high density polyethylene pipe, such as described above, and may have a different diameter, for example four or six inches, depending upon the particular application.

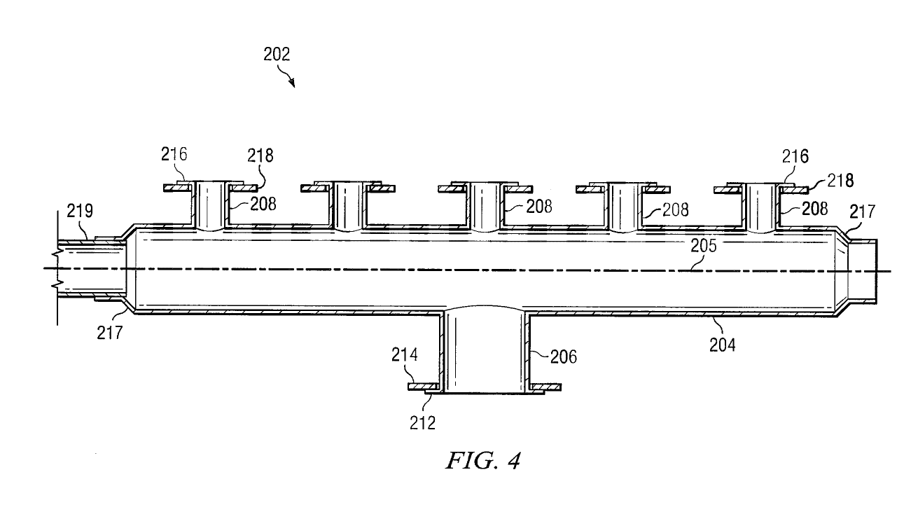

FIG. 4 is a schematic representation of a second embodiment of a manifold 202. As illustrated, manifold 202 includes a cylindrical main body 204, a cylindrical tank connection 206 and five cylindrical outlet connections 208, each extending from cylindrical main body 204 of the manifold. Each of main body 204, tank connection 206 and outlet connections 208 have the same diameters and connections as main body 104, tank connection 106 and outlet connections 108 of manifold 102, respectively. Each of main body 204, tank connection 206 and outlet connections 208 are also fabricated from the same high density polyethylene pipe as main body 104, tank connection 106 and outlet connections 108 of manifold 102, respectively.

Tank connection 206 and outlet connections 208 each extend from cylindrical main body 204 at an angle of ninety degrees relative to a longitudinal central axis 205 of the cylindrical main body. Cylindrical tank connection 206 and cylindrical outlet connections 208 are circumferentially spaced apart at 180°, e.g., they extend from opposite sides of the cylindrical main body 204 of manifold 202. In other embodiments, outlet connections 208 may extend from main body 204 of manifold 202 at angles other than ninety degrees relative to the central longitudinal axis of the main body, for example at thirty, or forty-fives degrees. Some or all of outlet connections 208 may also be circumferentially spaced on main body 204 at angles other than 180° from tank connection 206.

In the embodiment illustrated in FIG. 4, main body 204 is approximately 78 inches long with tank connection 206 located at the center of the main body. Five outlet connections 208 are spaced at 12 inch (center-to-center) intervals along the length of main body. Main body 204 and tank connection 206 of manifold 202 are fabricated from SDR 11 high density polyethylene pipe, described above. Outlet connections 208 are each fabricated from SDR 7 high density polyethylene pipe having the properties described above. Tank connection 206 is provided with a 10 inch beveled flange adapter 212 with a ductile iron back up ring 214 for connection to a tank flange such as illustrated in FIG. 3.

Outlet connections 208 are provided with four inch beveled flange connectors 216 with ductile iron back up rings 218 for connection to valves 115 (FIG. 1) or another fitting. Manifold 202 may also include a reducer 217 and a stainless steel extension pipe 219 having a nominal diameter of eight inches at one or both ends of main body 204 for connecting the manifold to a manifold of an adjacent tank or another pipe fitting. Reducer 217 may be formed from the same high density polyethylene described above while pipe extension 219 may be fabricated from suitable stainless steel such as 304 stainless pipe.

It will be appreciated by those skilled in the art having the benefit of this disclosure that the high density polyethylene acid and water tank manifold described herein provides an economical alternative to conventional steel manifolds for use in acid service, particularly in fracking operations. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A manifold for use with a tank in acid service, comprising:
a cylindrical main body having a central longitudinal axis;
a plurality of parallel outlet connections in fluid communication with the cylindrical main body, wherein the outlet connections are spaced apart at equal intervals along the main body and extend perpendicular to the central longitudinal axis of the main body;
a tank connection in fluid communication with the main body and extending perpendicular to the central longitudinal axis of the main body from the cylindrical main body of the manifold, wherein the tank connection is parallel to the outlet connections and circumferentially spaced apart from the outlet connections by 180° on the main body of the manifold and wherein the tank connection is positioned between and equidistant from an inner most two of the outlet connections; and
wherein the cylindrical main body, the tank connection and outlet connections are each fabricated from a high density polyethylene having a density of from 0.956 to 0.964 gm/cm³.

2. The manifold of claim 1, wherein the manifold is fabricated from a high density polyethylene having a melt index of <0.15 gm/10 min. a flexural modulus of 110,000 to 160,000 psi and a tensile strength of >3600 psi.

3. The manifold of claim 2, wherein the high density polyethylene has a slow crack growth rate of >1000 hours, environmental stress cracking rate of >5000 hours in 100% Igepal and a hydrostatic design basis of 1600 psi.

4. The manifold of claim 1, wherein the ratio of the diameter of the main body to the diameter of the tank connection is 1:1.

5. The manifold of claim 1, wherein the ratio of the diameter of the main body to the diameter of outlet connections is 10:4.

6. The manifold of claim 1, wherein the manifold further comprises a high density polyethylene reducer at each end of the manifold and a stainless steel extension pipe section extending from the reducer.

7. The manifold of claim 1, wherein the tank connection and main body of the manifold have a nominal diameter of ten inches and are formed from a high density polyethylene pipe having an SDR of 11 and wherein the outlet connections are formed from a high density polyethylene pipe having a nominal diameter of four inches and an SDR of 7.

8. A manifold for use with a tank in acid service, comprising:
a cylindrical main body having a central longitudinal axis;
a plurality of parallel outlet connections in fluid communication with the cylindrical main body, wherein the outlet connections are spaced apart at equal intervals along the main body and extend perpendicular to the central longitudinal axis of the main body;
a tank connection in fluid communication with the main body and extending perpendicular to the central longitudinal axis of the main body from the cylindrical main body of the manifold, wherein the tank connection is parallel to the outlet connections and circumferentially spaced apart from the outlet connections by 180° on the main body of the manifold and wherein a central longitudinal tank connection is positioned between and equidistant from an inner most two of the outlet connections; and
wherein the cylindrical main body, the tank connection and outlet connections are each fabricated from a high density polyethylene having a density of from 0.956 to 0.964 gm/cm³.
